(19) United States
(12) Patent Application Publication
(10) Pub. No.: US 2024/0411832 A1
(43) Pub. Date: Dec. 12, 2024

(54) CALCULATION DEVICE, CALCULATION METHOD, AND COMPUTER PROGRAM PRODUCT

(71) Applicants: KABUSHIKI KAISHA TOSHIBA, Tokyo (JP); TOSHIBA DIGITAL SOLUTIONS CORPORATION, Kawasaki-shi Kanagawa (JP)

(72) Inventor: Masaru SUZUKI, Ota Tokyo (JP)

(73) Assignees: KABUSHIKI KAISHA TOSHIBA, Tokyo (JP); TOSHIBA DIGITAL SOLUTIONS CORPORATION, Kawasaki-shi Kanagawa (JP)

(21) Appl. No.: 18/734,674

(22) Filed: Jun. 5, 2024

(30) Foreign Application Priority Data
Jun. 7, 2023 (JP) 2023-093971

(51) Int. Cl. G06F 17/11

(52) U.S. Cl. CPC G06F 17/11

(57) ABSTRACT

A calculation device includes a prediction unit, a selection unit, an update unit, a repetitive control unit, and an output unit. The prediction unit performs, for each weight-pattern, predicting the amount of increase in Pareto hypervolume by using a corresponding weight-pattern. The selection unit performs selecting a maximum weight-pattern with the largest amount of increase. The update unit performs updating a candidate solution set by acquiring, from a solver device, multiple solutions in a problem of minimizing a composite objective function being a linear weighted sum of multiple objective functions and multiple weight coefficients represented by the maximum weight-pattern, and adding the acquired multiple solutions to the candidate solution set. The repetitive control unit performs repeating the prediction, the selection, and the update. The output unit outputs a set including a non-inferior solution in the candidate solution set as an approximate Pareto solution set.

### CROSS-REFERENCE TO RELATED APPLICATIONS

This application is based upon and claims the benefit of priority from Japanese Patent Application No. 2023-093971, filed on Jun. 7, 2023; the entire contents of which are incorporated herein by reference.

### FIELD

Embodiments described herein relate generally to a calculation device, a calculation method, and a computer program product.

### BACKGROUND

In most optimization problems in the real world, an optimal solution is not determined by a single evaluation value, but is determined by considering multiple evaluation values. Such optimization problems using such multiple evaluation values are called multi-objective optimization problems. In the multi-objective optimization problem, an ideal solution is called a Pareto solution. The multi-objective optimization problem has multiple Pareto solutions with different balances of evaluation values. Most optimization problems in the real world are based on such multiple Pareto solutions, and an optimal solution is determined by considering trade-offs among multiple evaluation values.

A constraint method, a linear weighted sum method, and a multi-objective optimization method are known as methods for solving multi-objective optimization problems and calculating multiple Pareto solutions.

The constraint method represents one of multiple evaluation values by an objective function, and represents the other evaluation values as constraints. Subsequently, the constraint method solves a solution that optimizes the objective function under the restrictions by the constraints, which means constraint conditions, by using an optimization solver. However, the constraint method is difficult to rationally determine the constraints. The constraint method is not able to obtain multiple Pareto solutions with different balances unless the solution that optimizes the objective function is solved multiple times by changing the constraints.

The linear weighted sum method represents each of multiple evaluation values by an individual objective function. Furthermore, the linear weighted sum method calculates a linear weighted sum of multiple objective functions and multiple weight coefficients to generate a composite objective function. However, the linear weighted sum method is difficult to rationally determine the multiple weight coefficients. The linear weighted sum method is not able to obtain multiple Pareto solutions with different balances unless the solution that optimizes the composite objective function is solved multiple times by changing the multiple weight coefficients. The linear weighted sum method is not able to obtain a Pareto solution for a concave portion when a set including a feasible solution is non-convex.

The multi-objective optimization method solves a multi-objective optimization problem with a multi-objective optimization solver. However, for the multi-objective optimization solver, an algorithm is complex and an amount of calculation becomes huge.

### BRIEF DESCRIPTION OF THE DRAWINGS

FIG. 1 is a diagram illustrating a calculation system according to a first embodiment;

FIG. 2 is a diagram for explaining a Pareto solution;

FIG. 3 is a diagram for explaining Pareto hypervolume when the number of candidate solutions is one;

FIG. 4 is a diagram for explaining Pareto hypervolume when the number of candidate solutions is three;

FIG. 5 is a diagram for explaining the amount of increase in Pareto hypervolume;

FIG. 6 is a diagram illustrating the configuration of a calculation device according to the first embodiment;

FIG. 7 is a flowchart illustrating the process flow of the calculation device according to the first embodiment;

FIG. 8 is a flowchart illustrating the process flow of S16;

FIG. 9 is a diagram illustrating an approximate Pareto solution when a multi-objective optimization problem is solved by the technique of Japanese Patent Application Laid-open No. 2022-118555;

FIG. 10 is a diagram illustrating an approximate Pareto solution when a multi-objective optimization problem is solved by the technique of Yoshihiko Ozaki, Yuki Tanigaki, Shuhei Watanabe and Masaki Onishi, “Multiobjective Tree-structured Parzen Estimator for Computationally Expensive Optimization Problems”, Association for Computing Machinery, The Genetic and Evolutionary Computation Conference, 2020 June, pp. 533-541;

FIG. 11 is a diagram illustrating an approximate Pareto solution when a multi-objective optimization problem is solved by the calculation device according to the first embodiment;

FIG. 12 is a diagram for explaining an approximate Pareto solution calculated by the calculation device according to the first embodiment when a set of feasible solutions is non-convex;

FIG. 13 is a diagram illustrating the configuration of a calculation device according to a second embodiment;

FIG. 14 is a diagram illustrating the configuration of a calculation device according to a third embodiment;

FIG. 15 is a flowchart illustrating the process flow of the calculation device according to the third embodiment;

FIG. 16 is a flowchart illustrating the process flow of S41;

FIG. 17 is a diagram illustrating an approximate Pareto solution set calculated by the calculation device according to the third embodiment when a set of feasible solutions is non-convex;

FIG. 18 is a diagram illustrating the configuration of a calculation device according to a fourth embodiment; and

FIG. 19 is a hardware block diagram of the calculation device.

### DETAILED DESCRIPTION

The problem to be solved by the present disclosure is to provide a calculation device, a calculation method, and a computer program product that can accurately calculate multiple approximate Pareto solutions in a multi-objective minimization problem with a small amount of calculation.

A calculation device according to an embodiment calculates an approximate Pareto solution set including approximate Pareto solutions that approximate Pareto solutions in a multi-objective minimization problem for minimizing multiple objective functions. The calculation device includes a function acquisition unit, a prediction unit, a selection unit, an update unit, a repetitive control unit, and an output unit. The function acquisition unit acquires the multiple objective functions. The prediction unit performs, for each of multiple weight patterns representing multiple weight coefficients corresponding one-to-one to the multiple objective functions, a prediction process of predicting an amount of increase in Pareto hypervolume being hypervolume of an inferior solution region when a candidate solution set including candidate solutions being candidates of the approximate Pareto solutions is updated using a corresponding weight pattern. The selection unit performs a selection process of selecting, as a maximum weight pattern, a weight pattern with a largest amount of increase among the multiple weight patterns. The update unit performs an update process of updating the candidate solution set by acquiring, from a solver device, multiple solutions in a problem of minimizing a composite objective function being a linear weighted sum of the multiple objective functions and the multiple weight coefficients represented by the maximum weight pattern, and adding, as the candidate solutions, at least some of the acquired multiple solutions to the candidate solution set. The repetitive control unit performs repetitive control of repeating the prediction process, the selection process, and the update process. The output unit, after the repetitive control is terminated, selects a non-inferior solution among the candidate solutions included in the candidate solution set and outputs a set including the selected non-inferior solution as the approximate Pareto solution set.

Exemplary embodiments of a calculation device, a calculation method, and a computer program product will be explained below in detail with reference to the accompanying drawings. The present disclosure is not limited to the following embodiments.

### First Embodiment

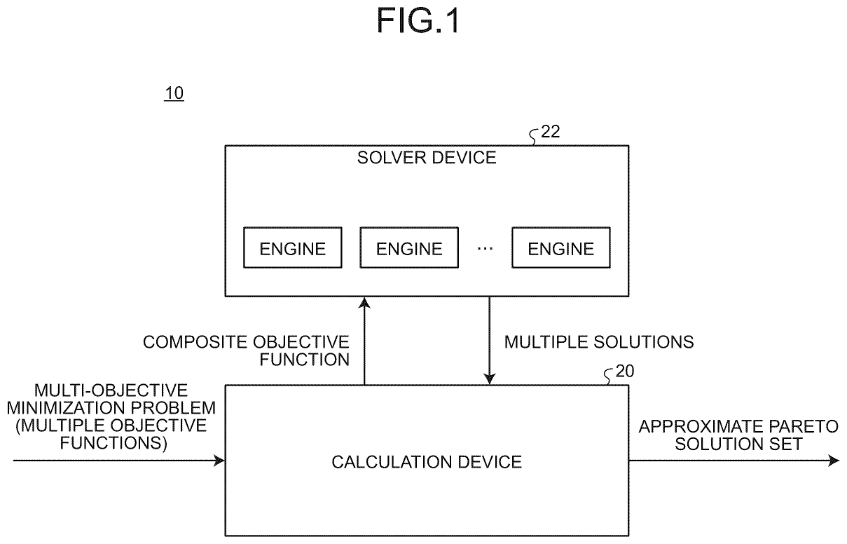

FIG. 1 is a diagram illustrating the functional configuration of a calculation system 10.

The calculation system 10 includes a calculation device 20 and a solver device 22.

The calculation device 20 calculates an approximate Pareto solution set including approximate Pareto solutions that approximate Pareto solutions in a multi-objective minimization problem of minimizing multiple objective functions. The calculation device 20 is implemented by one or more hardware processors, computers, or servers executing a computer program.

In a process of calculating the approximate Pareto solution set, the calculation device 20 repeatedly generates different composite objective functions by changing a weight pattern. The composite objective function is a linear weighted sum of multiple objective functions and multiple weight coefficients represented by weight patterns. Each time the calculation device 20 generates a composite objective function, the calculation device 20 gives the generated composite objective function to the solver device 22 and acquires multiple solutions that minimize the composite objective function from the solver device 22.

The solver device 22 performs a solving process of finding a solution that minimizes the given function. Subsequently, the solver device 22 outputs multiple solutions for the given composite objective function.

The solver device 22 solves not only an exact solution but also an approximate solution by solving a problem of minimizing the composite objective function by using a heuristic solution algorithm. This allows the solver device 22 to output multiple solutions that minimize the given composite objective function. Note that among a large number of solutions obtained by solving problems using the heuristic solution algorithm, the solver device 22 outputs, for example, multiples solutions where a value obtained by substituting the solution into the composite objective function is smaller than a predetermined value, or for example, a predetermined number of solutions in ascending order of values obtained by substituting the solution into the composite objective function.

The solver device 22 may be any device capable of obtaining multiple solutions that minimize a function. For example, the solver device 22 may be a device using a quantum annealing technology or a pseudo-quantum annealing technology.

In the present embodiment, the solver device 22 solves problems by using simulated bifurcation algorithms. The simulated bifurcation algorithms are described, for example, in Hayato Goto, Kosuke Tatsumura and Alexander R. Dixon, “Combinatorial optimization by simulating adiabatic bifurcations in nonlinear Hamiltonian systems,” Science Advances 5, eaav2372, 2019; and Hayato Goto, Kotaro Endo, Masaru Suzuki, Yoshisato Sakai, Taro Kanao, Yohei Hamakawa, Ryo Hidaka, Masaya Yamasaki and Kosuke Tatsumura, “High-performance combinatorial optimization based on classical mechanics”, Science Advances 7, eabe7953, 2021, as well as Japanese Patent Application Laid-open Nos. 2021-043667 and 2021-043589. The simulated bifurcation algorithm is also called a quantum-inspired algorithm because it was found by an inspiration from quantum mechanical optimization methods based on a quantum adiabatic theorem. The simulated bifurcation algorithm can solve combinatorial optimization problems where a cost function is a quadratic function of multiple binary decision variables, that is, quadratic unconstrained binary optimization (QUBO) problems. The simulated bifurcation algorithm can also solve combinatorial optimization problems where a cost function is a cubic or higher-order function of multiple binary decision variables, that is, higher order binary optimization (HUBO) problems. The simulated bifurcation algorithm for solving the HUBO problem is disclosed, for example, in Japanese Patent Application Laid-open No. 2021-043667. The simulated bifurcation algorithm can also solve combinatorial optimization problems including continuous-valued variables in some or all of multiple decision variables. The simulated bifurcation algorithm for solving combinatorial optimization problems including continuous-valued variables in some or all of the multiple decision variables are disclosed, for example, in Japanese Patent Application Laid-open No. 2021-043589.

In the present embodiment, the solver device 22 includes multiple engines each independently executes the simulated bifurcation algorithm. The solver device 22 outputs multiple solutions for one given composite objective function by executing the multiple engines in parallel. The solver device 22 may output multiple solutions by allowing one engine to repeatedly execute the simulated bifurcation algorithm multiple times.

The simulated bifurcation algorithm uses multiple position variables and multiple momentum variables that correspond one-to-one to the multiple decision variables included in the given composite objective function. At the start of execution, the simulated bifurcation algorithm sets groups of initial values for the multiple position variables or the multiple momentum variables. When the groups of initial values set for the multiple position variables and the multiple momentum variables are different, the simulated bifurcation algorithm is more likely to output different approximate solutions. In the present embodiment, the solver device 22 outputs multiple solutions by setting multiple groups of initial values, which are different from each other, for the multiple position variables or the multiple momentum variables used by each of the multiple engines.

The multi-objective minimization problem, the composite objective function, and the evaluation value are described below.

Equation (1) represents multiple objective functions included in the multi-objective minimization problem.

$$\{ \begin{matrix}{f}_{1} ( x ) = {f}_{1} ( {x}_{1} , {x}_{2} , ⋯ , {x}_{n} , ⋯ , {x}_{N} ) \\ {f}_{2} ( x ) = {f}_{2} ( {x}_{1} , {x}_{2} , ⋯ , {x}_{n} , ⋯ , {x}_{N} ) \\ ⋮ \\ {f}_{m} ( x ) = {f}_{m} ( {x}_{1} , {x}_{2} , ⋯ , {x}_{n} , ⋯ , {x}_{N} ) \\ ⋮ \\ {f}_{M} ( x ) = {f}_{M} ( {x}_{1} , {x}_{2} , ⋯ , {x}_{n} , ⋯ , {x}_{N} )\end{matrix} \qquad ( 1 )$$

Each of f₁(x), f₂(x), . . . , fₘ(x), . . . , and f_{M}(x) represents an objective function. M represents the number of multiple objective functions and is an integer equal to or greater than 2. m represents an index that identifies any one of the multiple objective functions and is an integer equal to or greater than 1 and equal to or smaller than M. fₘ(x) represents the m^{th} objective function among the M objective functions.

Each of x₁, x₂, . . . , xₙ, . . . , and x_{N} represents a decision variable. N represents the number of multiple decision variables included in the multiple objective functions and is an integer equal to or greater than 2. n represents an index that identifies any one of the multiple decision variables and is an integer equal to or greater than 1 and equal to or smaller than N. xₙ represents the n^{th} decision variable among the multiple decision variables.

Each of the multiple objective functions may not include any of the multiple decision variables. That is, each of the multiple objective functions may have a coefficient of zero for a term including any of the multiple decision variables.

The multiple decision variables and the multiple objective functions are variables and functions that can be solved by the solver device 22. For example, when the solver device 22 solves the QUBO problem, each of the multiple decision variables is a binary variable and each of the multiple objective functions is a quadratic function. When the solver device 22 can solve the HUBO problem, each of the multiple decision variables is a binary variable, and each of the multiple objective functions is a third or higher-order function that can be solved by the solver device 22. When the solver device 22 can solve optimization problems including decision variables representing continuous values, the multiple decision variables may include decision variables that are continuous values.

The calculation device 20 may receive a multi-objective optimization problem of maximizing some or all of multiple objective functions. In this case, by the calculation device 20, the objective function to be maximized among the multiple objective functions is multiplied by a negative value, and is thereby converted to an objective function to be minimized. This allows the calculation device 20 to calculate an approximate Pareto solution set by converting a multi-objective optimization problem of maximizing some or all of the multiple objective functions into a multi-objective minimization problem.

Equation (2) represents a weight pattern W. Equation (3) represents a composite objective function F(x).

$$W = ( {w}_{1} , {w}_{2} , ⋯ , {w}_{m} , ⋯ , {w}_{M} ) \qquad ( 2 )$$

$$F ( x ) = {w}_{1} {f}_{1} ( x ) + {w}_{2} {f}_{2} ( x ) + ⋯ + {w}_{m} {f}_{m} ( x ) + ⋯ + {w}_{M} {f}_{M} ( x ) \qquad ( 3 )$$

The weight pattern W represents multiple weight coefficients that correspond one-to-one to multiple objective functions. Each of the multiple weight coefficients is a real number greater than zero.

Each of w₁, w₂, . . . , wₘ, . . . , and w_{M} represents a weight coefficient. wₘ represents the m^{th} weight coefficient among the multiple weight coefficients. The m^{th} weight coefficient corresponds to fₘ(x) that is the m^{th} objective function.

The composite objective function F(x) is a linear weighted sum of the multiple objective functions f₁(x), f₂(x), . . . , fₘ(x), . . . , and f_{M}(x) and the multiple weight coefficients w₁, w₂, . . . , wₘ, . . . , and w_{M} represented by the weight pattern W. That is, the composite objective function F(x) is a function obtained by adding the multiple objective functions, each of which is multiplied by a corresponding weight coefficient among the multiple weight coefficients, to the multiple objective functions, respectively.

Equation (4) represents an evaluation value of the m^{th} objective function fₘ(x).

$$Evaluation value of {f}_{m} ( x ) = {f}_{m} ( {x}_{1} , {x}_{2} , ⋯ , {x}_{n} , ⋯ , {x}_{N} ) \qquad ( 4 )$$

The evaluation value of the objective function is obtained by substituting the solution that minimizes the composite objective function obtained by the solver device 22 into multiple decision variables included in a corresponding objective function. The evaluation value of the objective function is a value that evaluates the obtained solution, and is represented by a real number and the smaller the better.

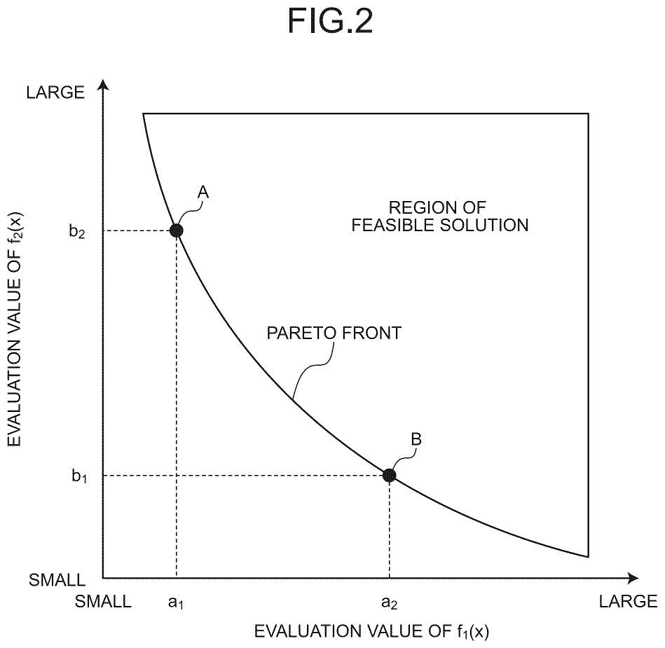

FIG. 2 is a diagram for explaining a Pareto solution of the multi-objective minimization problem of minimizing two objective functions. In FIG. 2, a horizontal axis represents an evaluation value of the first objective function f₁(x), and a vertical axis represents an evaluation value of the second objective function f₂(x).

In the multi-objective minimization problem, a feasible solution is a solution that satisfies all of multiple objective functions. In the multi-objective minimization problem, a Pareto solution is a non-inferior solution in which no superior solution exists among multiple feasible solutions. For example, in the multi-objective minimization problem, the Pareto solution is a solution having the smallest evaluation value for any of the multiple objective functions in a state where evaluation values of the other objective functions are minimized.

In the example in FIG. 2, each of A and B is one of the Pareto solutions. A has the smallest evaluation value for the second objective function f₂(x) when the evaluation value of the first objective function f₁(x) is fixed to a₁, and has the smallest evaluation value for the first objective function f₁(x) when the evaluation value of the second objective function f₂(x) is fixed to b₂. In the example in FIG. 2, B has the smallest evaluation value for the second objective function f₂(x) when the evaluation value of the first objective function f₁(x) is fixed to a₂, and has the smallest evaluation value for the first objective function f₁(x) when the evaluation value of the second objective function f₂(x) is fixed to b₁.

A Pareto front represents a curved surface connecting multiple Pareto solutions. Note that when the multi-objective minimization problem includes two objective functions, the Pareto front is a curve.

The calculation device 20 calculates an approximate Pareto solution set including approximate Pareto solutions that approximate such Pareto solutions. The approximate Pareto solutions are non-inferior solutions that are close to the Pareto front. However, the approximate Pareto solution may be a Pareto solution that is strictly tangent to the Pareto front. Accordingly, the approximate Pareto solution set includes not only Pareto solutions that are strictly tangent to the Pareto front, but also approximate Pareto solutions that are close to the Pareto front. Note that all solutions included in the approximate Pareto solution set may be Pareto solutions.

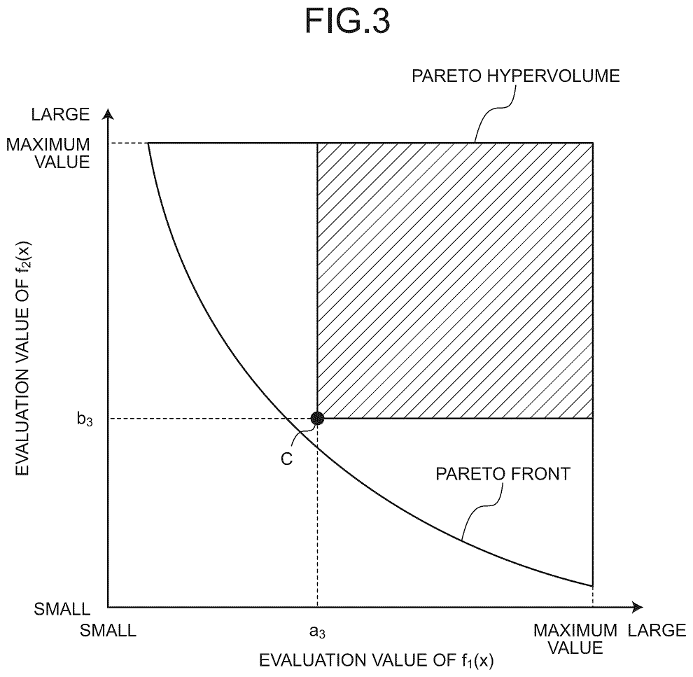

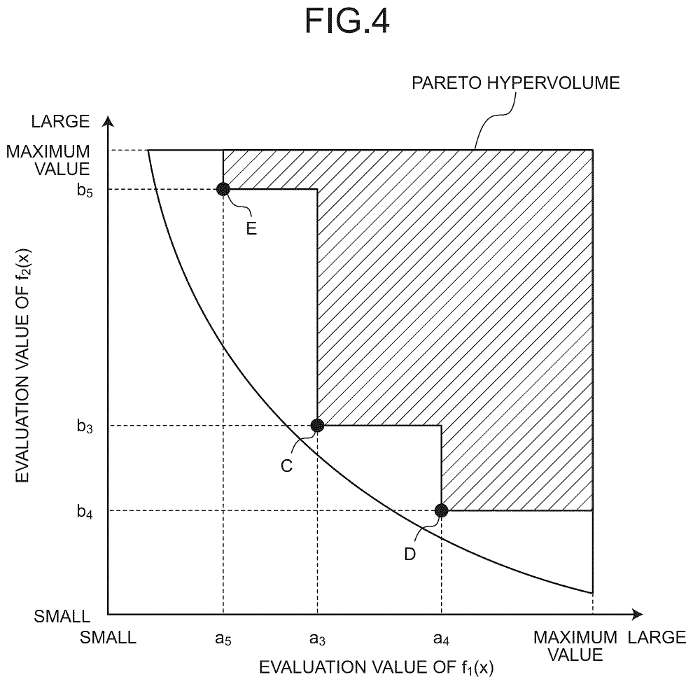

FIG. 3 is a diagram for explaining Pareto hypervolume when the number of candidate solutions is one. FIG. 4 is a diagram for explaining Pareto hypervolume when the number of candidate solutions is three. In FIGS. 3 and 4, a horizontal axis represents the evaluation value of the first objective function f₁(x), and a vertical axis represents the evaluation value of the second objective function f₂(x).

The calculation device 20 repeats a process of calculating candidate solutions that are candidates for approximate Pareto solutions while changing a weight pattern, thereby increasing the number of candidate solutions. After performing the process of calculating the candidate solutions a predetermined number of times or until sufficiently good candidate solutions are obtained, the calculation device 20 selects multiple approximate Pareto solutions from the calculated multiple candidate solutions.

The calculation device 20 predicts the amount of increase in the Pareto hypervolume as an indicator for selecting a weight pattern to be used in the process of calculating the candidate solutions.

The Pareto hypervolume represents the size of an inferior solution region in a candidate solution set including one or more candidate solutions that have already been calculated.

The inferior solution region is a region of feasible solutions, which satisfy all of the multiple objective functions, where no candidate solution included in the candidate solution set is selected as a non-inferior solution. The non-inferior solution is a solution for which no other superior solution exists in the candidate solution set. That is, the inferior solution region is a region where even if a new candidate solution is added within the region, the new added candidate solution is not selected as an approximate Pareto solution.

The Pareto hypervolume represents an area when the multi-objective minimization problem includes two objective functions, and represents a volume when the multi-objective minimization problem includes three objective functions.

As illustrated in FIG. 3, assume that C is the only candidate solution included in the candidate solution set. In C, the evaluation value of the first objective function f₁(x) is a₃ and the evaluation value of the second objective function f₂(x) is b₃. In this case, the Pareto hypervolume represents the size of a range in the region of feasible solutions where the evaluation value of the first objective function is equal to or greater than a₃ and the evaluation value of the second objective function is equal to or greater than b₃. That is, the Pareto hypervolume in this case represents the size of a range in the region of feasible solutions, excluding a range where the evaluation value of the first objective function is smaller than a₃ and a range where the evaluation value of the second objective function is smaller than b₃.

As illustrated in FIG. 4, assume that the candidate solutions included in the candidate solution set are C, D, and E. In D, the evaluation value of the first objective function f₁(x) is a₄ and the evaluation value of the second objective function f₂(x) is b₄. In E, the evaluation value of the first objective function f₁(x) is as and the evaluation value of the second objective function f₂(x) is b₅. In this case, the Pareto hypervolume represents the size of a range in the region of feasible solutions, which is obtained by combining a range where the evaluation value of the first objective function is equal to or greater than a₃ and the evaluation value of the second objective function is equal to or greater than b₃, a range where the evaluation value of the first objective function is equal to or greater than a₄ and the evaluation value of the second objective function is equal to or greater than b₄, and a range where the evaluation value of the first objective function is equal to or greater than as and the evaluation value of the second objective function is equal to or greater than b₅.

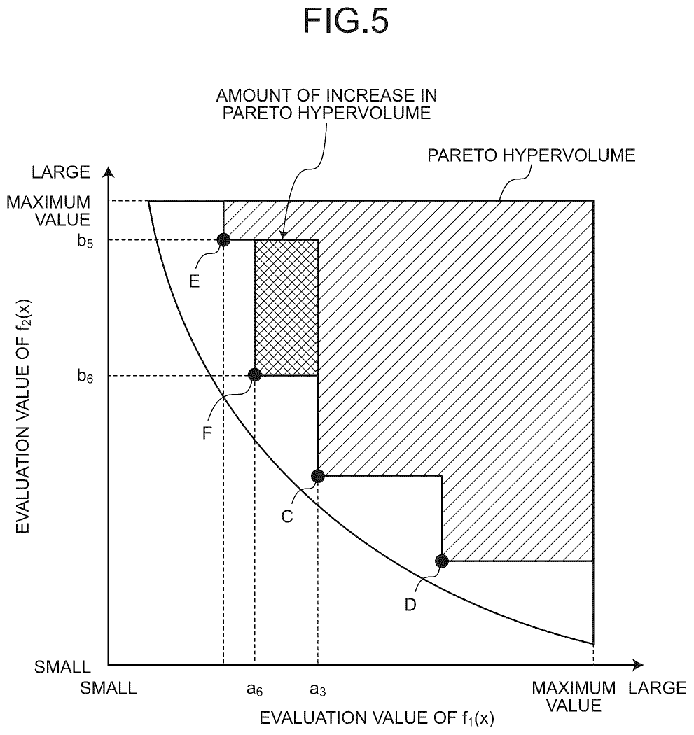

FIG. 5 is a diagram for explaining the amount of increase in Pareto hypervolume. In FIG. 5, a horizontal axis represents the evaluation value of the first objective function f₁(x) and a vertical axis represents the evaluation value of the second objective function f₂(x).

When a new candidate solution is added outside the inferior solution region in one or more candidate solutions included in the already calculated candidate solution set, the Pareto hypervolume is increased. The amount of increase in the Pareto hypervolume represents an increment in such a case. F is a new candidate solution added to the candidate solution set including C, D, and E. In F, the evaluation value of the first objective function f₁(x) is a₆ and the evaluation value of the second objective function f₂(x) is b₆. When F is added, the amount of increase in the Pareto hypervolume is (a₃−a₆)×(b₅−b₆).

For each weight pattern generated, the calculation device 20 according to the present embodiment performs a process of predicting the amount of increase in the Pareto hypervolume in a candidate solution calculated by a composite objective function generated using the generated weight pattern.

The process of predicting the amount of increase in the Pareto hypervolume can be accomplished by the existing technique. For example, in Yoshihiko Ozaki, Yuki Tanigaki, Shuhei Watanabe and Masaki Onishi, “Multiobjective Tree-structured Parzen Estimator for Computationally Expensive Optimization Problems”, Association for Computing Machinery, The Genetic and Evolutionary Computation Conference, 2020 June, pp. 533-541, an algorithm for predicting the amount of increase in Pareto hypervolume of a composite objective function on the basis of one or more solutions and weight patterns is disclosed. The Preferred Networks, OPTUNA® also provides a computer program for predicting the amount of increase in Pareto hypervolume of a composite objective function on the basis of one or more solutions and weight patterns. The calculation device 20 may predict the amount of increase in Pareto hypervolume by using these techniques.

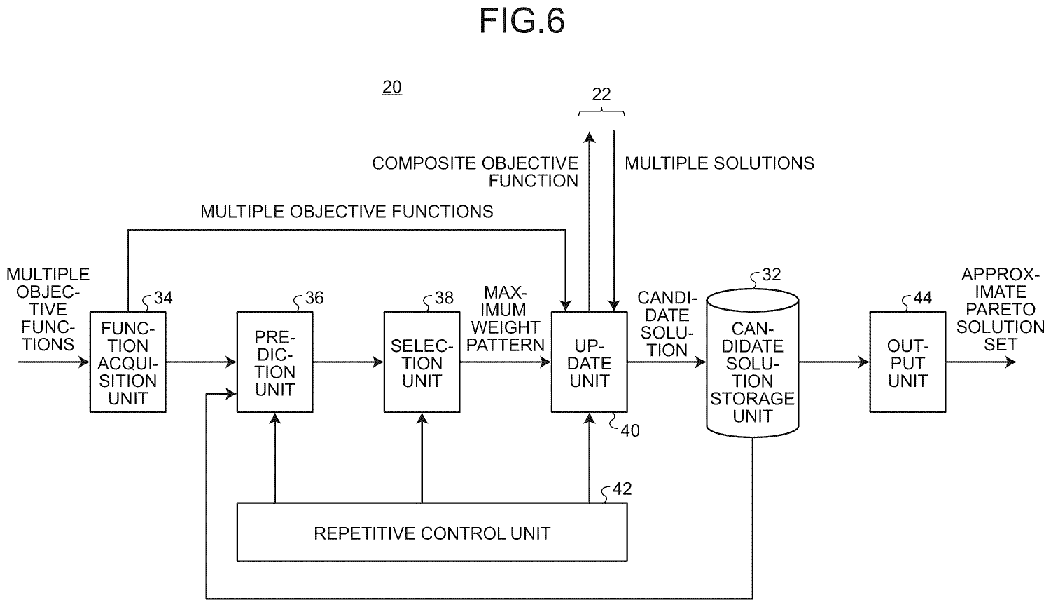

FIG. 6 is a diagram illustrating the configuration of the calculation device 20 according to the first embodiment.

The calculation device 20 according to the first embodiment includes a candidate solution storage unit 32, a function acquisition unit 34, a prediction unit 36, a selection unit 38, an update unit 40, a repetitive control unit 42, and an output unit 44.

The candidate solution storage unit 32 stores therein a candidate solution set including candidate solutions that are candidates for approximate Pareto solutions. The candidate solution set may be an empty set at the start of processing, or may include feasible solutions calculated in some other way.

The function acquisition unit 34 acquires multiple objective functions included in a multi-objective minimization problem.

The prediction unit 36 performs a prediction process. The prediction unit 36 generates multiple weight patterns different from each other in the prediction process. The prediction unit 36 may generate the multiple weight patterns on the basis of pre-registered information. The prediction unit 36 may also generate the multiple wait patterns on the basis of random numbers or the like. For each of the multiple weight patterns generated in the prediction process, the prediction unit 36 predicts the amount of increase in Pareto hypervolume when the candidate solution set is updated using a corresponding weight pattern. That is, for each of the multiple weight patterns generated in the prediction process, the prediction unit 36 predicts the amount of increase in the Pareto hypervolume when a solution that minimizes a composite objective function generated using the corresponding weight pattern is added to the candidate solution set as a new solution candidate.

The selection unit 38 acquires the multiple weight patterns generated by the prediction unit 36 and the predicted amount of increase in the Pareto hypervolume for each of the multiple weight patterns. The selection unit 38 performs a selection process of selecting, as a maximum weight pattern, a weight pattern with the largest amount of increase among the generated multiple weight patterns.

The update unit 40 acquires the multiple objective functions from the function acquisition unit 34 and acquires the maximum weight pattern from the selection unit 38. The update unit 40 performs an update process of updating the candidate solution set stored in the candidate solution storage unit 32. In the update process, the update unit 40 generates a composite objective function that is a linear weighted sum of the multiple objective functions and the multiple weight coefficients represented by the maximum weight pattern. In the update process, the update unit 40 further gives the composite objective function to the solver device 22 and acquires multiple solutions in a problem of minimizing the composite objective function from the solver device 22.

In the update process, the update unit 40 adds, as candidate solutions, at least some of the multiple solutions acquired from the solver device 22 to the candidate solution set stored in the candidate solution storage unit 32. For example, the calculation device 20 may add all of the multiple solutions acquired from the solver device 22 to the candidate solution set. For example, the update unit 40 may add, to the candidate solution set, a solution for which a value of the composite objective function is equal to or smaller than a predetermined reference value among the acquired multiple solutions. For example, the update unit 40 may add a predetermined number of solutions to the candidate solution set in an ascending order of the values of the composite objective function among the acquired multiple solutions.

The repetitive control unit 42 performs repetitive control of repeating the prediction process by the prediction unit 36, the selection process by the selection unit 38, and the update process by the update unit 40. The repetitive control unit 42 repeats the prediction process, the selection process, and the update process a predetermined number of times or for a predetermined amount of time. The repetitive control unit 42 may repeat the prediction process, the selection process, and the update process until the candidate solution set includes multiple candidate solutions of sufficiently suitable quantity or quality.

After the repetitive control is terminated, the output unit 44 selects a non-inferior solution among the candidate solutions included in the candidate solution set stored in the candidate solution storage unit 32. The output unit 44 outputs a set including the selected non-inferior solution as an approximate Pareto solution set. The output unit 44 may display the approximate Pareto solution set on a display device. For example, the output unit 44 may display, on the display device, a graph of a predetermined dimension with the evaluation values of all or some of the multiple objective functions as axes. This allows the output unit 44 to present a trade-off relationship among the multiple evaluation values to a user.

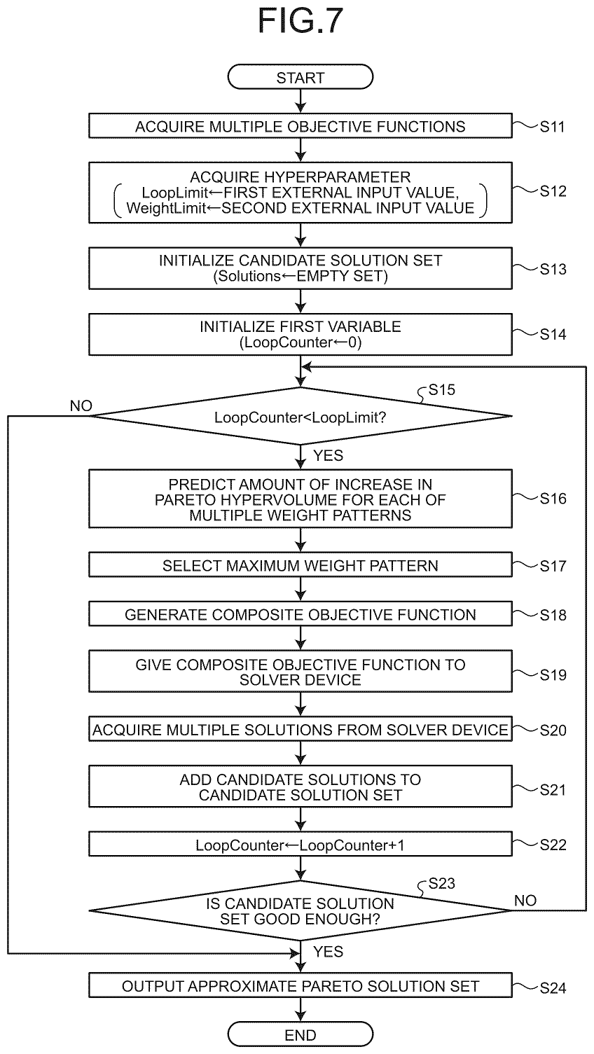

FIG. 7 is a flowchart illustrating the process flow of the calculation device 20 according to the first embodiment. In the first embodiment, the calculation device 20 performs the process in the flow illustrated in FIG. 7.

First, at S11, the calculation device 20 acquires multiple objective functions included in a multi-objective minimization problem.

Subsequently, at S12, the calculation device 20 acquires a first external input value given from the outside as a first hyperparameter (LoopLimit), and acquires a second external input value as a second hyperparameter (WeightLimit). More specifically, the calculation device 20 acquires the upper limit of the number of iterations as the first hyperparameter (LoopLimit), and acquires the number of multiple weight patterns as the second hyperparameter (WeightLimit).

Subsequently, at S13, the calculation device 20 initializes a candidate solution set Solutions stored in the candidate solution storage unit 32. More specifically, the calculation device 20 sets the candidate solution set Solutions to an empty set.

Subsequently, at S14, the calculation device 20 initializes a first variable (LoopCounter). For example, the calculation device 20 substitutes 0 into the first variable (LoopCounter).

Subsequently, at S15, the calculation device 20 determines whether the first variable (LoopCounter) is smaller than the first hyperparameter (LoopLimit). When the first variable (LoopCounter) is equal to or greater than the first hyperparameter (LoopLimit) (No at S15), the calculation device 20 advances the process to S24. When the first variable (LoopCounter) is smaller than the first hyperparameter (LoopLimit) (Yes at S15), the calculation device 20 advances the process to S16.

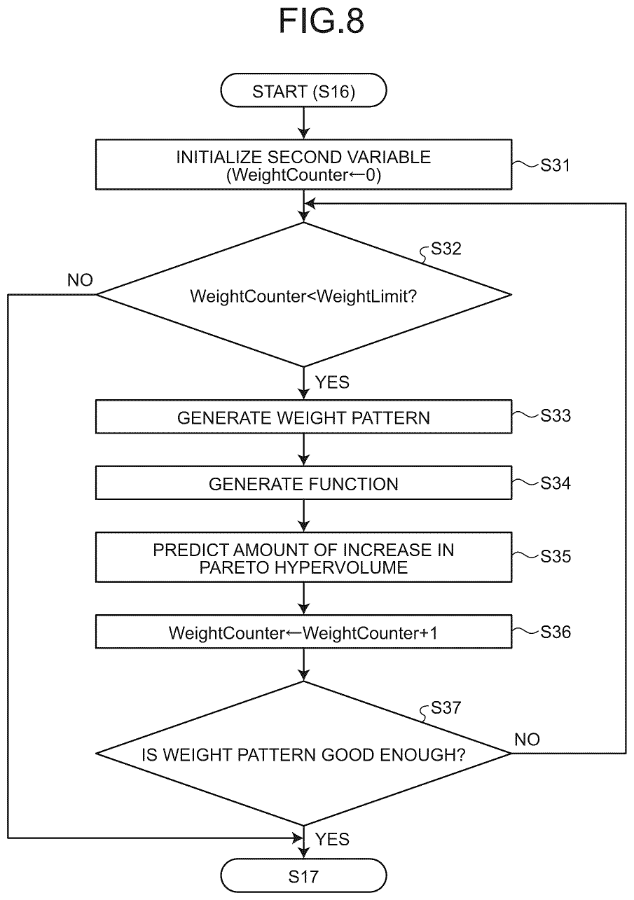

At S16, the calculation device 20 generates multiple weight patterns, and performs a prediction process of predicting the amount of increase in Pareto hypervolume when a current candidate solution set is updated by a corresponding weight pattern for each of the generated multiple weight patterns. Details of the process of S16 are described later with reference to FIG. 8.

Subsequently, at S17, the calculation device 20 performs a selection process of selecting, as a maximum weight pattern, a weight pattern with the largest amount of increase in the Pareto hypervolume among the multiple weight patterns generated at S16.

Subsequently, at S18, the calculation device 20 generates a composite objective function on the basis of the maximum weight pattern. More specifically, the calculation device 20 generates the composite objective function that is a linear weighted sum of the multiple objective functions and the multiple weight coefficients represented by the maximum weight pattern.

Subsequently, at S19, the calculation device 20 gives the generated composite objective function to the solver device 22. When the composite objective function is given, the solver device 22 calculates multiple solutions to a problem of minimizing the composite objective function. Subsequently, at S20, the calculation device 20 acquires the multiple solutions to the problem of minimizing the composite objective function calculated by the solver device 22.

At S21, the calculation device 20 adds at least some of the multiple solutions to the problem of minimizing the composite objective function acquired from the solver device 22 at S20 to the candidate solution set Solutions as candidate solutions. Subsequently, at S22, the calculation device 20 adds 1 to the first variable (LoopCounter).

Subsequently, at S23, the calculation device 20 determines whether the multiple candidate solutions included in the candidate solution set Solutions are good enough. When the multiple candidate solutions included in the candidate solution set Solutions are determined to be good enough (Yes at S23), the calculation device 20 advances the process to S24. When the multiple candidate solutions included in the candidate solution set Solutions are determined not to be good enough (No at S23), the calculation device 20 returns the process to S15 and repeats the processes from S15.

At S24, the calculation device 20 selects a non-inferior solution among the multiple candidate solutions included in the candidate solution set Solutions. Subsequently, the calculation device 20 outputs a set including the selected non-inferior solution to an external device as an approximate Pareto solution set.

After terminating the process of S24, the calculation device 20 terminates the present flow.

FIG. 8 is a flowchart illustrating the process flow of S16 of the calculation device 20 according to the first embodiment. In the prediction process of S16, the calculation device 20 performs the process in the flow illustrated in FIG. 8.

First, at S31, the calculation device 20 initializes a second variable (WeightCounter). For example, the calculation device 20 substitutes 0 into the second variable (WeightCounter).

Subsequently, at S32, the calculation device 20 determines whether the second variable (WeightCounter) is smaller than the second hyperparameter (WeightLimit). When the second variable (WeightCounter) is equal to or smaller than the second hyperparameter (WeightLimit) (No at S32), the calculation device 20 terminates the present flow and advances the process to S17 in FIG. 7. When the second variable (WeightCounter) is smaller than the second hyperparameter (WeightLimit) (Yes at S32), the calculation device 20 advances the process to S33.

At S33, the calculation device 20 generates a weight pattern. The calculation device 20 may select one weight pattern from multiple weight patterns different from each other prepared in advance. The calculation device 20 may also generate one weight pattern on the basis of random numbers or the like.

Subsequently, at S34, the calculation device 20 generates a function by calculating a linear weighted sum of the multiple objective functions and the multiple weight coefficients represented by the weight pattern generated at S33. That is, the calculation device 20 generates the function by adding the multiple objective functions multiplied by a corresponding weight coefficient among the multiple weight coefficients represented by the generated weight pattern.

Subsequently, at S35, the calculation device 20 predicts the amount of increase in Pareto hypervolume when the candidate solution set Solutions is updated using the generated weight pattern. That is, the calculation device 20 predicts the amount of increase in the Pareto hypervolume when a solution that minimizes the function generated at S34 is added to the candidate solution set Solutions as a new candidate solution. For example, the calculation device 20 predicts the amount of increase in the Pareto hypervolume on the basis of the algorithm disclosed in Yoshihiko Ozaki, Yuki Tanigaki, Shuhei Watanabe and Masaki Onishi, “Multiobjective Tree-structured Parzen Estimator for Computationally Expensive Optimization Problems”, Association for Computing Machinery, The Genetic and Evolutionary Computation Conference, 2020 June, pp. 533-541 or the computer program provided by Preferred Networks, OPTUNA®.

Subsequently, at S36, the calculation device 20 adds 1 to the second variable (WeightCounter).

Subsequently, at S37, the calculation device 20 determines whether the generated weight pattern is good enough. For example, when the amount of increase in the Pareto hypervolume is equal to or greater than a predetermined value or a predetermined percentage of the existing Pareto hypervolume, the calculation device 20 may determine that the generated weight pattern is good enough.

When the generated weight pattern is determined to be good enough (Yes at S37), the calculation device 20 terminates the present flow and advances the process to S17 in FIG. 7. When the generated weight pattern is determined not to be good enough (No at S37), the calculation device 20 returns the process to S32 and repeats the processes from S32.

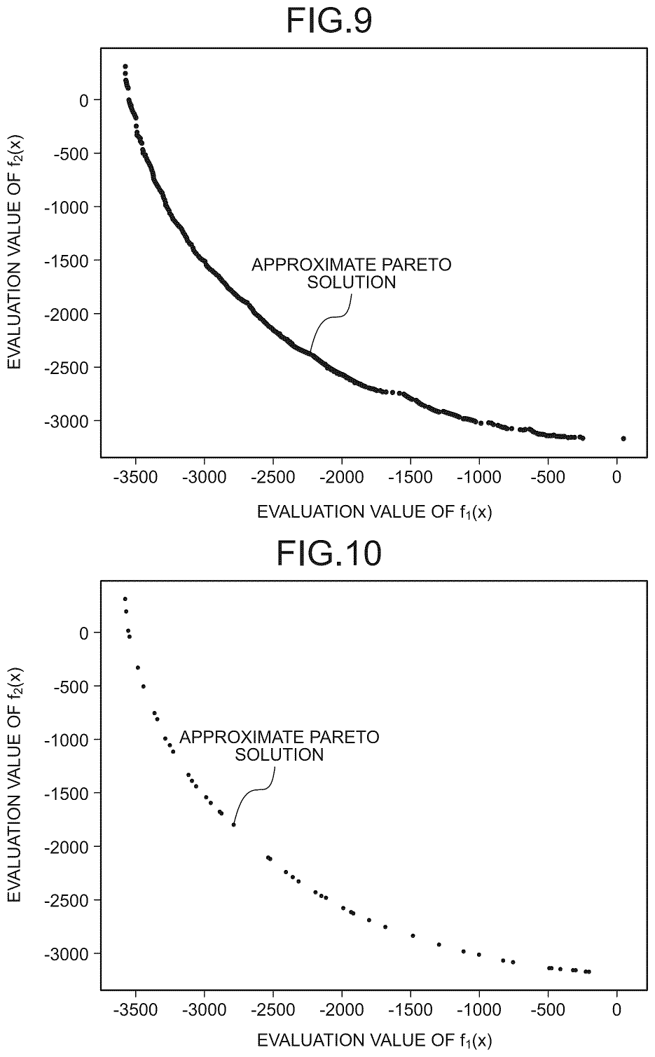

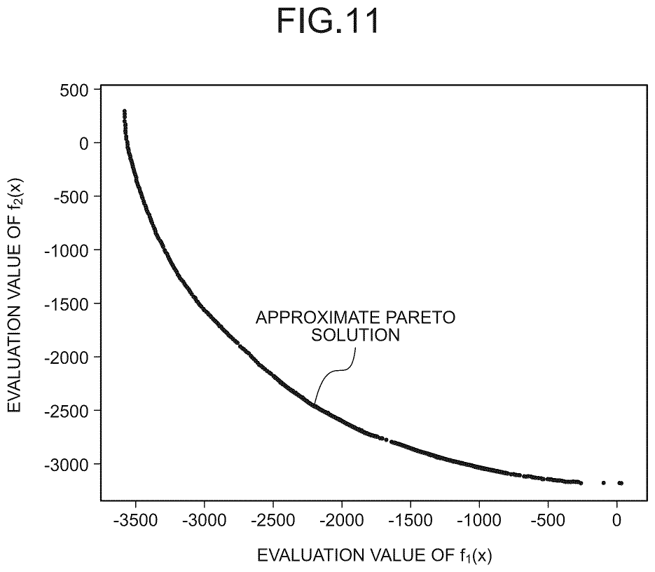

FIG. 9 is a diagram illustrating an approximate Pareto solution when a multi-objective optimization problem is solved by the technique of Japanese Patent Application Laid-open No. 2022-118555. FIG. 10 is a diagram illustrating an approximate Pareto solution when a multi-objective optimization problem is solved by the technique of Yoshihiko Ozaki, Yuki Tanigaki, Shuhei Watanabe and Masaki Onishi, “Multiobjective Tree-structured Parzen Estimator for Computationally Expensive Optimization Problems”, Association for Computing Machinery, The Genetic and Evolutionary Computation Conference, 2020 June, pp. 533-541. FIG. 11 is a diagram illustrating an approximate Pareto solution when a multi-objective optimization problem is solved by the calculation device 20 according to the first embodiment.

In the examples in FIGS. 9, 10, and 11, the same multi-objective optimization problem of minimizing two objective functions f₁(x) and f₂(x) is solved. In the examples in FIGS. 9, 10, and 11, for example, the calculation device 20 uses the same weight pattern and optimization solver, and the process is performed by the same computing device for the same solving time.

Compared to the technique of Japanese Patent Application Laid-open No. 2022-118555 and the technique of Yoshihiko Ozaki, Yuki Tanigaki, Shuhei Watanabe and Masaki Onishi, “Multiobjective Tree-structured Parzen Estimator for Computationally Expensive Optimization Problems”, Association for Computing Machinery, The Genetic and Evolutionary Computation Conference, 2020 June, pp. 533-541, the calculation device 20 according to the first embodiment can generate an approximate Pareto solution set including a sufficiently large number of approximate Pareto solutions close to a Pareto front and further including a sufficiently large number of approximate Pareto solutions to fill the Pareto front without gaps.

As described above, in accordance with the calculation system 10 according to the first embodiment, multiple approximate Pareto solutions in a multi-objective minimization problem can be accurately calculated with a small amount of calculation.

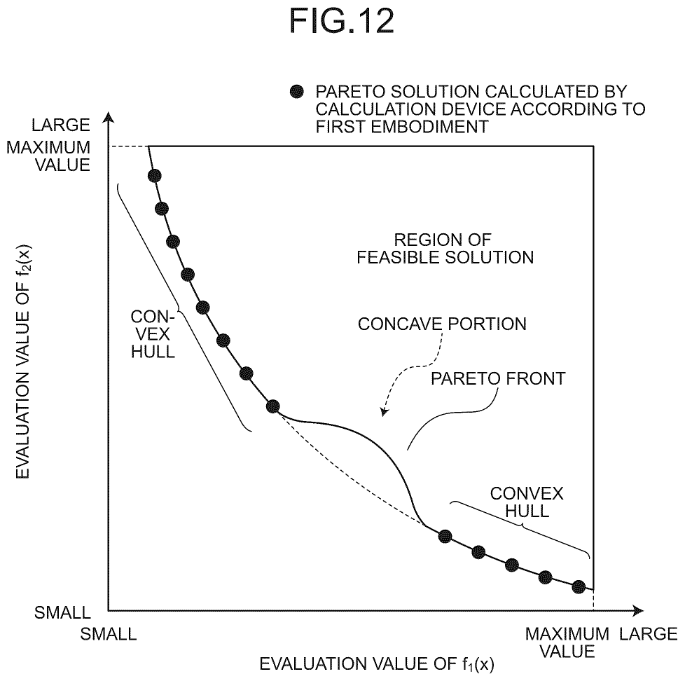

FIG. 12 is a diagram for explaining an approximate Pareto solution calculated by the calculation device 20 according to the first embodiment when a set of feasible solutions is non-convex. In FIG. 12, a horizontal axis represents the evaluation value of the first objective function f₁(x) and a vertical axis represents the evaluation value of the second objective function f₂(x).

The calculation device 20 according to the first embodiment calculates multiple convex hull solutions included in a set that approximates a convex hull of a Pareto solution set.

Accordingly, when the set of feasible solutions is convex, the calculation device 20 according to the first embodiment can calculate an approximate Pareto solution set including approximate Pareto solutions in all smooth regions in a Pareto front. However, when the set of feasible solutions is non-convex, the calculation device 20 according to the first embodiment calculates an approximate Pareto solution set including no solutions that contact or are close to a concave portion in the Pareto front, as illustrated in FIG. 12.

For example, assume that the Pareto solution set is represented by [x₀²+x₁²=1, x₀≥0, x₁≥₀]. In this case, the calculation device 20 according to the first embodiment can calculate x=(1, 0) and x=0, 1 as approximate Pareto solutions. However, the calculation device 20 according to the first embodiment is not able to calculate x=(1/\sqrt{2}, 1/\sqrt{2}) as an approximate Pareto solution.

### Second Embodiment

A calculation system 10 according to the second embodiment is described below. Since the calculation system 10 according to the second embodiment has substantially the same functions and configurations as those of the calculation system 10 according to the first embodiment, components having substantially the same functions and configurations are denoted by the same symbols and detailed descriptions thereof are omitted except for differences.

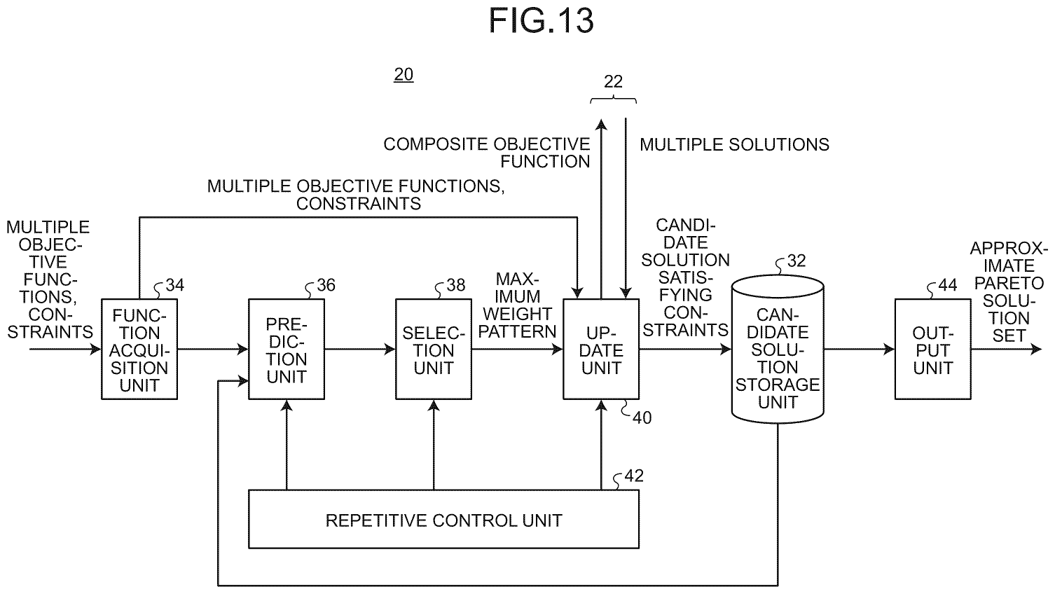

FIG. 13 is a diagram illustrating the configuration of a calculation device 20 according to the second embodiment.

In the calculation device 20 according to the second embodiment, the function acquisition unit 34 acquires constraints along with multiple objective functions. The constraints are expressed by constraint expressions such as equality or inequality including multiple decision variables included in the multiple objective functions. Subsequently, the function acquisition unit 34 gives the acquired constraints to the update unit 40.

The update unit 40 adds a solution satisfying the constraints among the multiple solutions acquired from the solver device 22 to the candidate solution set stored in the candidate solution storage unit 32 as a candidate solution. For example, the update unit 40 may determine whether the constraints are satisfied for each of the multiple solutions acquired from the solver device 22, and select the solution satisfying the constraint. The update unit 40 may also generate a penalty function having a smaller value when the constraints are satisfied, and give a composite objective function with the penalty function added to the solver device 22. This allows the solver device 22 to output multiple solutions satisfying the constraints with high probability.

The solver device 22 may receive the constraints and the function and output the multiple solutions satisfying the constraints. In this case, the update unit 40 gives the constraints to the solver device 22 along with the composite objective function, acquires the multiple solutions satisfying the constraints from the solver device 22, and adds at least some of the acquired multiple solutions to the candidate solution set as candidate solutions.

In accordance with the calculation system 10 according to the second embodiment as described above, multiple approximate Pareto solutions in a multi-objective minimization problem including constraints can be accurately calculated with a small amount of calculation.

### Third Embodiment

A calculation system 10 according to the third embodiment is described below. Since the calculation system 10 according to the third embodiment has substantially the same functions and configurations as those of the calculation system 10 according to the first embodiment, components having substantially the same functions and configurations are denoted by the same symbols and detailed descriptions thereof are omitted except for differences.

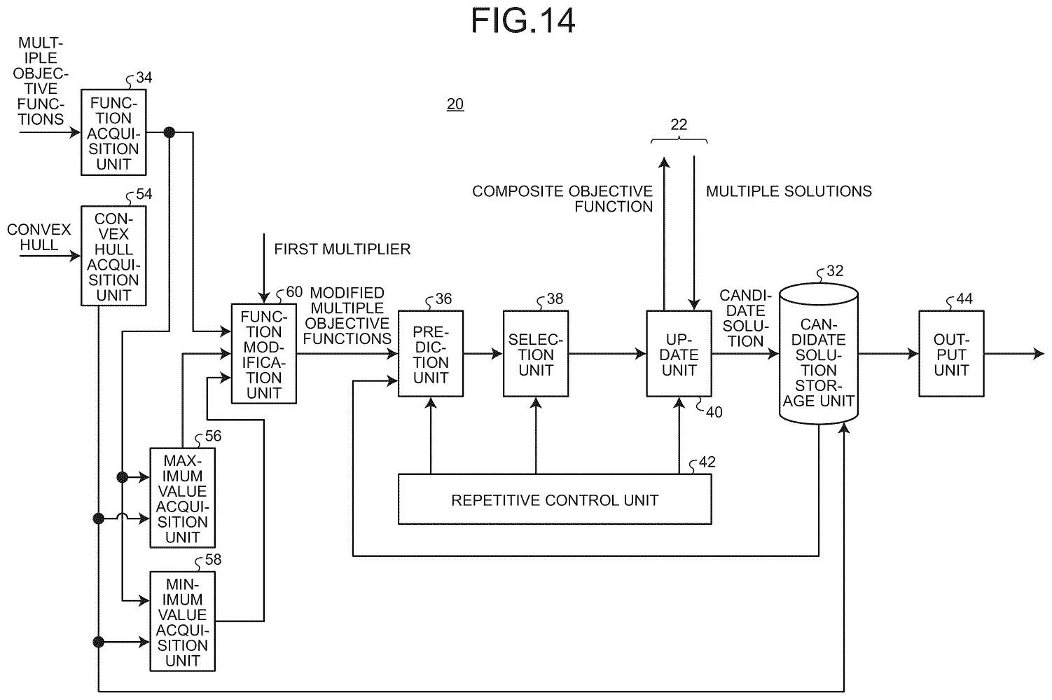

FIG. 14 is a diagram illustrating the configuration of a calculation device 20 according to the third embodiment.

Compared to the calculation device 20 according to the first embodiment illustrated in FIG. 6, the calculation device 20 according to the third embodiment further includes a convex hull acquisition unit 54, a maximum value acquisition unit 56, a minimum value acquisition unit 58, and a function modification unit 60.

The convex hull acquisition unit 54 acquires multiple convex hull solutions included in a set that approximates a convex hull of a Pareto solution set in a multi-objective minimization problem. For example, the convex hull acquisition unit 54 acquires, as the multiple convex hull solutions, the approximate Pareto solution set in the multi-objective minimization problem calculated by the calculation device 20 according to the first embodiment.

The maximum value acquisition unit 56 acquires the multiple objective functions acquired by the function acquisition unit 34 and the multiple convex hull solutions acquired by the convex hull acquisition unit 54. The maximum value acquisition unit 56 acquires, for each of the multiple objective functions, a maximum value among values that are each obtained by substituting each of the multiple convex hull solutions into a corresponding objective function.

The minimum value acquisition unit 58 acquires the multiple objective functions acquired by the function acquisition unit 34 and the multiple convex hull solutions acquired by the convex hull acquisition unit 54. The minimum value acquisition unit 58 acquires, for each of the multiple objective functions, a minimum value among the values that are each obtained by substituting each of the multiple convex hull solutions into the corresponding objective function.

The function modification unit 60 acquires the multiple objective functions acquired by the function acquisition unit 34, the maximum value acquired by the maximum value acquisition unit 56 for each of the multiple objective functions, and the minimum value acquired by the minimum value acquisition unit 58 for each of the multiple objective functions.

The function modification unit 60 is preset with a first multiplier that is a real number greater than 1. Subsequently, the function modification unit 60 modifies each of the multiple objective functions. More specifically, for each of the multiple objective functions, the function modification unit 60 multiplies a corresponding objective function by a coefficient and translates the multiplied objective function so as to become 0 when substituting a solution by which the minimum value is obtained, and to become 1 when substituting a solution by which the maximum value is obtained. Moreover, the function modification unit 60 multiplies each of the multiple objective functions by the coefficient, and exponentiates the multiplied objective function translated with the first multiplier to modify the corresponding objective function. This allows the function modification unit 60 to modify each of the multiple objective functions in a direction that makes the concave portion in the Pareto front convex.

The first multiplier may be any real number greater than 1. However, the first multiplier needs be a value that the composite objective function generated in the update unit 40 is solvable by the solver device 22.

The function modification unit 60 gives each of the modified multiple objective functions to the prediction unit 36. In the third embodiment, the repetitive control unit 42 performs repetitive control of repeating the prediction process in the prediction unit 36, the selection process in the selection unit 38, and the update process in the update unit 40 by using the modified multiple objective functions. Prior to the repetitive control, the convex hull acquisition unit 54 may incorporate multiple convex hull solutions included in the set approximating the convex hull of the acquired Pareto solution set into the candidate solution set stored in the candidate solution storage unit 32.

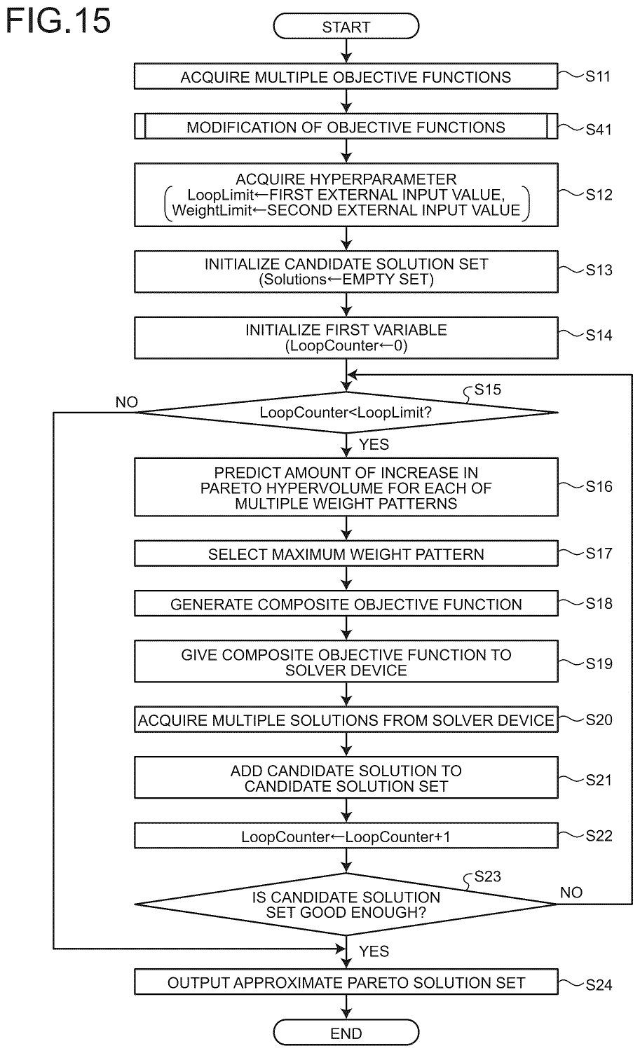

FIG. 15 is a flowchart illustrating the process flow of the calculation device 20 according to the third embodiment. In the third embodiment, the calculation device 20 performs the process in the flow illustrated in FIG. 15.

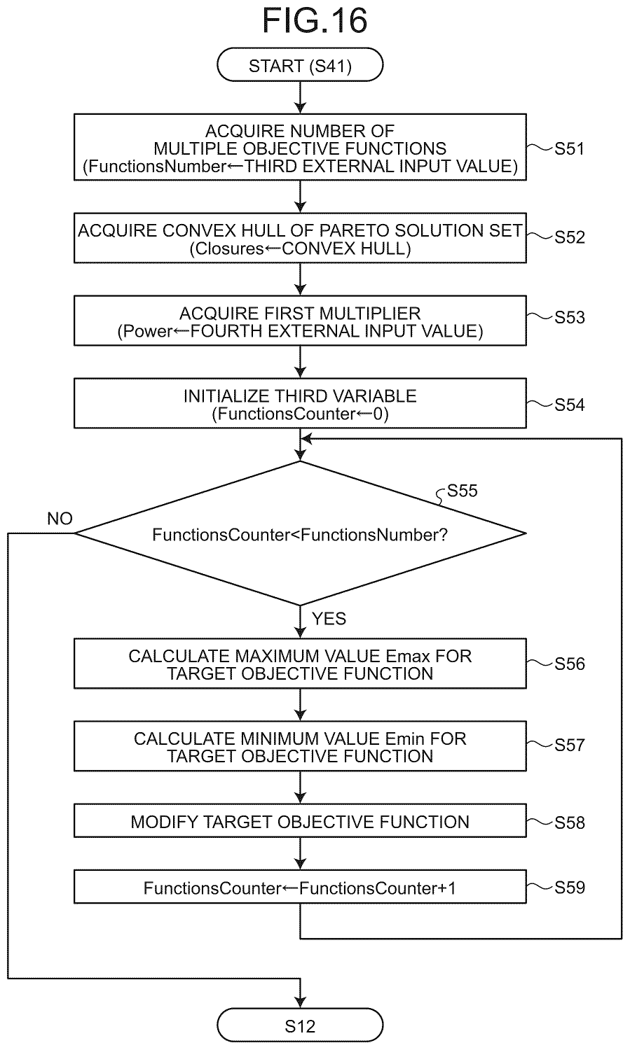

The third embodiment is different from the flowchart illustrated in FIG. 7 in that the calculation device 20 performs an objective function modification process of S41 between S11 and S12. That is, in the third embodiment, the calculation device 20 first acquires the multiple objective functions at S11, and then modifies each of the multiple objective functions at S41. Details of the process of S41 are described below with reference to FIG. 16. In the third embodiment, the calculation device 20 performs the processes of S13 to S24 subsequent to S41, as in the first embodiment.

FIG. 16 is a flowchart illustrating the process flow of S41 in the calculation device 20 according to the third embodiment. In the third embodiment, the calculation device 20 performs the process at S41 of FIG. 15 according to the flow illustrated in FIG. 16.

First, at 551, the calculation device 20 acquires a third external input value given from the outside as the number (FunctionsNumber) of multiple objective functions. The calculation device 20 may calculate the number (FunctionsNumber) of multiple objective functions by counting the multiple objective functions acquired at S11.

Subsequently, at S52, the calculation device 20 acquires a set Closures that approximates the convex hull of the Pareto solution set in the multi-objective minimization problem to be solved.

Subsequently, at S53, the calculation device 20 acquires a fourth external input value given from the outside as a first multiplier (Power). The first multiplier (Power) is a real number greater than 1.

Subsequently, at S54, the calculation device 20 initializes a third variable (FunctionsCounter). For example, the calculation device 20 substitutes 0 into the third variable (FunctionsCounter).

Subsequently, at S55, the calculation device 20 determines whether the third variable (FunctionsCounter) is smaller than the number (FunctionsNumber) of multiple objective functions. When the third variable (FunctionsCounter) is equal to or greater than the number (FunctionsNumber) of multiple objective functions (No at S55), the calculation device 20 terminates the present flow and advances the process to S12 in FIG. 15. When the third variable (FunctionsCounter) is smaller than the number (FunctionsNumber) of multiple objective functions (Yes at S55), the calculation device 20 advances the process to S56.

At S56, the calculation device 20 calculates a maximum value Emax for a target objective function identified by the third variable (FunctionsCounter) among the multiple objective functions. For example, the calculation device 20 calculates the maximum value on the basis of Equation (5).

$$Emax = max [ ObjectiveFunctions ( FunctionsCounter ) in Closures ] \qquad ( 5 )$$

ObjectiveFunctions(FunctionsCounter) represents one objective function identified by the third variable (FunctionsCounter) among the multiple objective functions. In Equation (5), max[ ] represents a function of selecting the maximum value from values obtained by substituting multiple solutions included in the set Closures approximating the convex hull into the objective function.

Subsequently, at S57, the calculation device 20 calculates a minimum value Emin for the target objective function identified in the third variable (FunctionsCounter) among the multiple objective functions. For example, the calculation device 20 calculates the minimum value on the basis of Equation (6).

$$Emin = min [ ObjectiveFunctions ( FunctionsCounter ) in Closures ] \qquad ( 6 )$$

In Equation (6), min[ ] represents a function of selecting the minimum value among the values obtained by substituting the multiple solutions included in the set Closures approximating the convex hull into the objective function.

Subsequently, at S58, the calculation device 20 modifies the target objective function identified by the third variable (FunctionsCounter) among the multiple objective functions. More specifically, the calculation device 20 multiplies the target objective function by a coefficient and translates the multiplied objective function so as to become 0 when substituting a solution by which the minimum value (Emin) is obtained, and to become 1 when substituting a solution by which the maximum value (Emax) is obtained, and exponentiates the multiplied objective function translated with the first multiplier (Power), to modify the target objective function.

For example, the calculation device 20 modifies the target objective function on the basis of Equation (7).

$$ObjectiveFunctions ( FunctionsCounter ) = \qquad ( 7 )$$

$$[ \{ ObjectiveFunctions ( FunctionsCounter ) - Emin \} / ( Emax - Emin ) ] \hat{} Power$$

In Equation (7), A\hat{ }B represents B power of A.

Subsequently, at S59, the calculation device 20 adds 1 to the third variable (FunctionsCounter). After terminating the process of S59, the calculation device 20 returns the process to S55 and repeats the processes from S55.

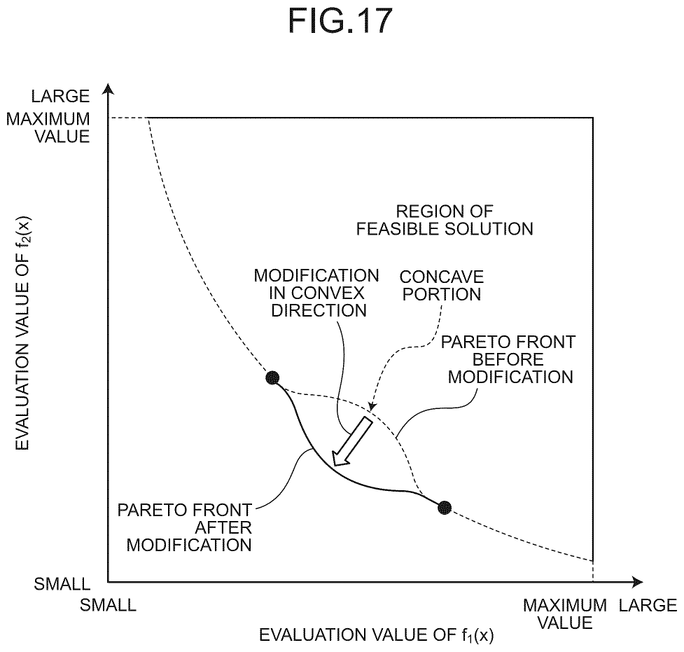

FIG. 17 is a diagram for explaining an approximate Pareto solution set calculated by the calculation device 20 according to the third embodiment when a set of feasible solutions is non-convex. In FIG. 17, a horizontal axis represents the evaluation value of the first objective function f₁(x) and a vertical axis represents the evaluation value of the second objective function f₂(x).

By modifying the multiple objective functions, the calculation device 20 according to the third embodiment modifies the concave portion in the Pareto front in the multi-objective minimization problem in a convex direction, as illustrated in FIG. 17. Since each of the modified multiple objective functions is modified to have a minimum value of 0 and a maximum value of 1 and then is exponentiated with a value greater than 1, no magnitude relationship is inverted and no feasible solutions are changed. Subsequently, each of the modified multiple objective functions changes the Pareto front in a convex direction by an exponentiation of a value greater than 1.

Accordingly, the calculation system 10 according to the third embodiment can calculate a solution that minimizes the modified multiple objective function in the same process as that of the calculation device 20 according to the first embodiment, thereby calculating an approximate Pareto solution set including approximate Pareto solutions in a concave portion in a Pareto front even when a set of feasible solutions of a multi-objective minimization problem is non-convex.

### Fourth Embodiment

A calculation system 10 according to the fourth embodiment is described below. Since the calculation system 10 according to the fourth embodiment has substantially the same functions and configurations as those of the calculation system 10 according to the third embodiment, components having substantially the same functions and configurations are denoted by the same symbols and detailed descriptions thereof are omitted except for differences.

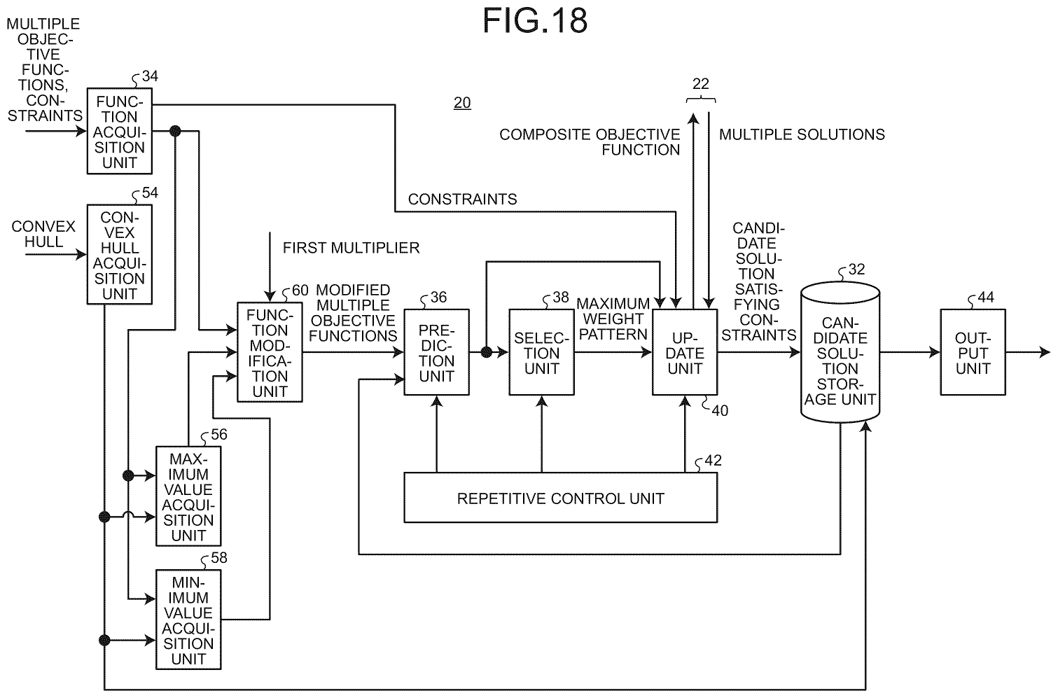

FIG. 18 is a diagram illustrating the configuration of a calculation device 20 according to the fourth embodiment.

In the calculation device 20 according to the fourth embodiment, the function acquisition unit 34 acquires constraints along with the multiple objective functions. The function acquisition unit 34 gives the acquired constraints to the maximum value acquisition unit 56, the minimum value acquisition unit 58, and the update unit 40.

The maximum value acquisition unit 56 acquires a maximum value for each of the multiple objective functions in the same manner as in the third embodiment, on the condition that the constraints are satisfied. That is, the maximum value acquisition unit 56 does not acquire, as the maximum value, a value obtained by substituting a solution not satisfying the constraints among multiple convex hull solutions into a corresponding objective function.

The minimum value acquisition unit 58 acquires a minimum value for each of the multiple objective functions in the same manner as in the third embodiment, on the condition that the constraints are satisfied. That is, the maximum value acquisition unit 56 does not acquire, as the minimum value, a value obtained by substituting a solution not satisfying the constraints among the multiple convex hull solutions into a corresponding objective function.

As in the second embodiment, the update unit 40 adds, as a candidate solution, a solution satisfying the constraints among the multiple solutions acquired from the solver device 22 to the candidate solution set stored in the candidate solution storage unit 32.

As described above, even when a set of feasible solutions of a multi-objective minimization problem is non-convex, the calculation system 10 according to the fourth embodiment can calculate an approximate Pareto solution set including approximate Pareto solutions in a concave portion in a Pareto front for the multi-objective minimization problem including constraints.

### Hardware Configuration

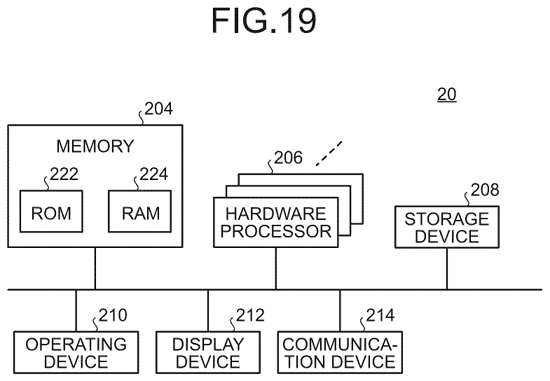

FIG. 19 is a hardware block diagram of the calculation device 20. The calculation device 20 is implemented by a hardware configuration similar to a general computer (information processing device) as illustrated in FIG. 19, as an example. The calculation device 20 may be implemented by one computer or server as illustrated in FIG. 19, or by multiple computers or servers working in concert. The calculation device 20 may be provided at a part thereof with dedicated hardware circuitry.

The calculation device 20 includes a memory 204, one or more hardware processors 206, a storage device 208, an operating device 210, a display device 212, and a communication device 214. The components are connected to one another by a bus.

The memory 204 includes, for example, a ROM 222 and a RAM 224. The ROM 222 stores therein computer programs, various setting information, and the like used to control the calculation device 20 in a non-rewritable manner. The RAM 224 is a volatile storage medium such as a synchronous dynamic random-access memory (SDRAM). The RAM 224 serves as a work area for the one or more hardware processors 206.

The one or more hardware processors 206 are connected to the memory 204 (the ROM 222 and the RAM 224) via the bus. Each of the one or more hardware processors 206 may be, for example, a central processing unit (CPU) or hardware circuitry for computing.

The one or more hardware processors 206 perform various processes in cooperation with various computer programs stored in advance in the ROM 222 or the storage device 208 using a predetermined area of the RAM 224 as a work area, and comprehensively control the operation of each component constituting the calculation device 20. In addition, the one or more hardware processors 206 control the operating device 210, the display device 212, the communication device 214, and the like in cooperation with the computer programs stored in advance in the ROM 222 or the storage device 208.

The storage device 208 is a rewritable storage device such as a semiconductor-based storage medium such as a flash memory, or a magnetically or optically recordable storage medium. The storage device 208 stores therein the computer programs, various setting information, and the like used to control the calculation device 20.

The operating device 210 is an input device such as a mouse and a keyboard. The operating device 210 receives information input by a user and outputs the received information to the one or more hardware processors 206.

The display device 212 displays information to the user. The display device 212 receives information and the like from the one or more hardware processors 206, and displays the received information. When outputting information to the communication device 214, the storage device 208, and the like, the calculation device 20 may not include the display device 212. The communication device 214 communicates with external devices to transmit and receive information via a network or the like.

The computer program to be executed by the calculation device 20 of the present embodiment is provided by being recorded on a computer-readable recording medium, such as a CD-ROM, a flexible disk (FD), a CD-R, and a digital versatile disc (DVD), in an installable or executable file format.

The computer program to be executed by the calculation device 20 of the present embodiment may be configured to be provided by being stored on a computer connected to a network such as the Internet and downloaded via the network. The computer program executed by the calculation device 20 of present embodiment may be configured to be provided or distributed via the network such as the Internet. The computer program to be executed by the calculation device 20 of present embodiment may be configured to be provided by being incorporated in advance in a ROM or the like.

The computer program for causing an information processing device to function as the calculation device 20 has a modular structure including, for example, a prediction module, a selection module, an update module, a repetitive control module, and an output module. The computer program may further include a convex hull acquisition module, a maximum value acquisition module, a minimum value acquisition module, and a function modification module. The computer program is executed by the one or more hardware processors 206, whereby each module is loaded into the RAM 224 of the memory 204 and causes the one or more hardware processors 206 to function as the function acquisition unit 34, the prediction unit 36, the selection unit 38, the update unit 40, the repetitive control unit 42, and the output unit 44. The computer program may further cause the one or more hardware processors 206 to function as the convex hull acquisition unit 54, the maximum value acquisition unit 56, the minimum value acquisition unit 58, and the function modification unit 60. The computer program also causes the memory 204 and the storage device 208 to function as the candidate solution storage unit 32. Some of all of these components may be configured by hardware.

The calculation device 20 may be implemented, for example, by a reconfigurable semiconductor device such as a field-programmable gate array (FPGA). The calculation device 20 may be implemented by a CPU, a microprocessor, a graphics processing unit (GPU), an application specific integrated circuit (ASIC), or electronic circuitry including these circuits. The calculation device 20 may be implemented by an information processing device such as a computer, a computer system including multiple computers or servers communicating with each other via a network, or a PC cluster in which multiple computers cooperate to perform information processing.

When the calculation device 20 is implemented by a reconfigurable semiconductor device such as an FPGA, circuit information (configuration data) written to the reconfigurable semiconductor device to cause the reconfigurable semiconductor device to operate as the calculation device 20 may be configured to be provided by being stored on a computer connected to a network such as the Internet and downloaded via the network. The circuit information (configuration data) to be written to the reconfigurable semiconductor device to cause the reconfigurable semiconductor device to operate as the calculation device 20 may be configured to be provided by being recorded on a computer-readable recording medium.

When the calculation device 20 is implemented by a semiconductor device such as an ASIC, circuit information representing the configuration of circuitry described by a hardware description language to cause the semiconductor device such as an ASIC to operate as the calculation device 20 may be configured to be provided by being stored on a computer connected to a network such as the Internet and downloaded via the network. In order to cause a semiconductor device such as an ASIC to operate as the calculation device 20, circuit information representing the configuration of circuitry described by a hardware description language may be configured to be provided by being recorded on a computer-readable recording medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A calculation device that calculates an approximate Pareto solution set including approximate Pareto solutions that approximate Pareto solutions in a multi-objective minimization problem for minimizing multiple objective functions, the calculation device comprising:
a function acquisition unit that acquires the multiple objective functions;
a prediction unit that, for each of multiple weight patterns representing multiple weight coefficients corresponding one-to-one to the multiple objective functions, performs a prediction process of predicting an amount of increase in Pareto hypervolume being hypervolume of an inferior solution region when a candidate solution set including candidate solutions being candidates of the approximate Pareto solutions is updated using a corresponding weight pattern;
a selection unit that performs a selection process of selecting, as a maximum weight pattern, a weight pattern with a largest amount of increase among the multiple weight patterns;
an update unit that performs an update process of updating the candidate solution set by acquiring, from a solver device, multiple solutions in a problem of minimizing a composite objective function being a linear weighted sum of the multiple objective functions and the multiple weight coefficients represented by the maximum weight pattern, and adding, as the candidate solutions, at least some of the acquired multiple solutions to the candidate solution set;
a repetitive control unit that performs repetitive control of repeating the prediction process, the selection process, and the update process; and
an output unit that, after the repetitive control is terminated, selects a non-inferior solution among the candidate solutions included in the candidate solution set and outputs a set including the selected non-inferior solution as the approximate Pareto solution set.

2. The calculation device according to claim 1, wherein the inferior solution region is a region of feasible solutions where a candidate solution included in the candidate solution set is not selected as the non-inferior solution, the feasible solutions satisfying all of the multiple objective functions.

3. The calculation device according to claim 1, wherein the update unit adds, as the candidate solutions, a predetermined number of solutions, for which a value of the composite objective function is equal to or smaller than a predetermined reference value among the acquired multiple solutions, to the candidate solution set, or adds the predetermined number of solutions to the candidate solution set in an ascending order of values of the composite objective function.

4. The calculation device according to claim 1, wherein the composite objective function is a function obtained by adding the multiple objective functions, each of the multiple objective functions being multiplied by a corresponding weight coefficient among the multiple weight coefficients.

5. The calculation device according to claim 1, wherein the prediction unit predicts the amount of increase in the Pareto hypervolume when a solution is added to the candidate solution set as the candidate solution, the solution minimizing a function obtained by adding the multiple objective functions multiplied by the multiple weight coefficients represented by the corresponding weight pattern.

6. The calculation device according to claim 1, wherein
the function acquisition unit further acquires a constraint, and
the update unit adds a solution satisfying the constraint among the multiple solutions to the candidate solution set as the candidate solution.

7. The calculation device according to claim 1, further comprising:
a convex hull acquisition unit that acquires multiple convex hull solutions included in a set that approximate a convex hull of a Pareto solution set in the multi-objective minimization problem;
a maximum value acquisition unit that acquires, for each of the multiple objective functions, a maximum value among values that are each obtained by substituting each of the multiple convex hull solutions into a corresponding objective function;
a minimum value acquisition unit that acquires, for each of the multiple objective functions, a minimum value among the values that are each obtained by substituting each of the multiple convex hull solutions into the corresponding objective function; and
a function modification unit that multiplies each of the multiple objective functions by a coefficient and translates the multiplied objective function so as to become 0 when substituting a solution by which the minimum value is obtained and to become 1 when substituting a solution by which the maximum value is obtained, and exponentiates the multiplied objective function translated with a first multiplier greater than 1 and set in advance to modify each of the multiple objective functions, wherein
the repetitive control unit performs the repetitive control of repeating the prediction process, the selection process, and the update process by using the modified multiple objective functions.

8. The calculation device according to claim 7, wherein, prior to the repetitive control, the repetitive control unit incorporates the multiple convex hull solutions into the candidate solution set.

9. The calculation device according to claim 7, wherein
the function acquisition unit further acquires a constraint, and
the update unit adds a solution satisfying the constraint among the multiple solutions to the candidate solution set as the candidate solution.

10. A calculation method for calculating, by circuitry of an information processing device, an approximate Pareto solution set including approximate Pareto solutions that approximate Pareto solutions in a multi-objective minimization problem for minimizing multiple objective functions, the calculation method comprising:
acquiring, by the information processing device, the multiple objective functions;
performing, by the information processing device, for each of multiple weight patterns representing multiple weight coefficients corresponding one-to-one to the multiple objective functions, a prediction process of predicting an amount of increase in Pareto hypervolume being hypervolume of an inferior solution region when a candidate solution set including candidate solutions being candidates of the approximate Pareto solutions is updated using a corresponding weight pattern;
performing, by the information processing device, a selection process of selecting, as a maximum weight pattern, a weight pattern with a largest amount of increase among the multiple weight patterns;
performing, by the information processing device, an update process of updating the candidate solution set by acquiring, from a solver device, multiple solutions in a problem of minimizing a composite objective function being a linear weighted sum of the multiple objective functions and the multiple weight coefficients represented by the maximum weight pattern, and adding, as the candidate solutions, at least some of the acquired multiple solutions to the candidate solution set;
performing, by the information processing device, repetitive control of repeating the prediction process, the selection process, and the update process; and
selecting, by the information processing device, after the repetitive control is terminated, a non-inferior solution among the candidate solutions included in the candidate solution set, and outputting a set including the selected non-inferior solution as the approximate Pareto solution set.

11. A computer program product having a non-transitory computer readable medium including programmed instructions stored thereon, wherein the instructions, when executed by circuitry of an information processing device, cause the information processing device to function as a calculation device that calculates an approximate Pareto solution set including approximate Pareto solutions that approximate Pareto solutions in a multi-objective minimization problem for minimizing multiple objective functions, the instructions causing the calculation device to perform:
acquiring the multiple objective functions;
for each of multiple weight patterns representing multiple weight coefficients corresponding one-to-one to the multiple objective functions, performing a prediction process of predicting an amount of increase in Pareto hypervolume being hypervolume of an inferior solution region when a candidate solution set including candidate solutions being candidates of the approximate Pareto solutions is updated using a corresponding weight pattern;
performing a selection process of selecting, as a maximum weight pattern, a weight pattern with a largest amount of increase among the multiple weight patterns;
performing an update process of updating the candidate solution set by acquiring, from a solver device, multiple solutions in a problem of minimizing a composite objective function being a linear weighted sum of the multiple objective functions and the multiple weight coefficients represented by the maximum weight pattern, and adding, as the candidate solutions, at least some of the acquired multiple solutions to the candidate solution set;
performing repetitive control of repeating the prediction process, the selection process, and the update process; and
after the repetitive control is terminated, selecting a non-inferior solution among the candidate solutions included in the candidate solution set and outputting a set including the selected non-inferior solution as the approximate Pareto solution set.
